(19) United States
(12) Patent Application Publication
(10) Pub. No.: US 2022/0252404 A1
(43) Pub. Date: Aug. 11, 2022

(54) SELF-CORRECTING VEHICLE LOCALIZATION

(71) Applicant: Ford Global Technologies, LLC, Dearborn, MI (US)

(72) Inventors: Ankit Girish Vora, Ann Arbor, MI (US); Krishanth Krishnan, Windsor/Ontario (CA); Christopher Meissen, Redwood City, CA (US); Gaurav Pandey, College Station, TX (US); Siddharth Agarwal, Ann Arbor, MI (US)

(73) Assignee: Ford Global Technologies, LLC, Dearborn, MI (US)

(21) Appl. No.: 17/172,457

(22) Filed: Feb. 10, 2021

(51) Int. Cl. G01C 21/28; G08G 1/01; G08G 1/052; G08G 1/017; G08G 1/16

(52) U.S. Cl. CPC G01C 21/28; G08G 1/0116; G08G 1/16; G08G 1/052; G08G 1/017; G08G 1/0112

(57) ABSTRACT

A system includes a computer for a vehicle including a processor and a memory. The memory stores instructions executable by the processor to determine a first location of the vehicle, to send the first location to a stationary infrastructure element, to receive, from the stationary infrastructure element, a second location of the vehicle determined from (a) infrastructure sensor data upon identifying the vehicle from a plurality of vehicles, and (b) the first location sent by the vehicle, and to determine a third location of the vehicle based on the infrastructure-determined second location and the first location.

### BACKGROUND

One or more computers can be programmed to monitor and/or control operations of a vehicle, e.g., as a vehicle travels on a road, based on vehicle location and orientation. A computer may determine a location and/or orientation of the vehicle based on data received from vehicle sensors and/or remote computers, e.g., in other vehicles. However, such data may be prone to error, which can be a serious problem, e.g., if the location and/or orientation data is being used to autonomously or semi-autonomously operate the vehicle.

### BRIEF DESCRIPTION OF THE DRAWINGS

FIG. 1 is a diagram illustrating an example vehicle localization system.

FIG. 2 shows a flowchart of an exemplary process for operating the vehicle.

FIG. 3 is a flowchart, of an exemplary process for operating the infrastructure element.

### DETAILED DESCRIPTION

### Introduction

Disclosed herein is a system including a computer for a vehicle including a processor and a memory. The memory stores instructions executable by the processor to determine a first location of the vehicle, send the first location to a stationary infrastructure element, receive, from the stationary infrastructure element, a second location of the vehicle determined from (a) infrastructure sensor data upon identifying the vehicle from a plurality of vehicles, and (b) the first location sent by the vehicle, and determine a third location of the vehicle based on the infrastructure-determined second location and the first location.

The instructions may further include instructions to determine a first vehicle state vector including the first location, a vehicle orientation, a vehicle linear velocity vector, a vehicle angular velocity vector, and a vehicle acceleration vector, and determine a second vehicle state vector based on (a) the third location and (b) the first vehicle state vector.

The instructions may further include instructions to determine the second vehicle state vector by applying a Kalman filter to the first vehicle state vector.

The instructions may further include instructions to identify the vehicle from a plurality of detected vehicles within a field of view of an infrastructure element object detection sensor upon determining that the detected vehicle is within an area defined based on the first location of the vehicle received from the vehicle.

The instructions may further include instructions to identify the vehicle within the field of view of the infrastructure object detection sensor upon determining that a difference between (i) an orientation of the detected vehicle in the image and (ii) a vehicle orientation included in the data received from the vehicle, is less than a threshold.

The object detection data may include at least one off a camera image, radar data, or lidar data.

The instructions may further include instructions to send the third location to the stationary infrastructure element, receive, from the stationary infrastructure element, a fourth location of the vehicle determined from (a) infrastructure sensor data upon identifying the vehicle from a plurality of vehicles, and (b) the third location sent by the vehicle, and determine a fifth location of the vehicle based on the infrastructure-determined fourth location and the third location.

Further disclosed herein is a method including sending, to a stationary infrastructure element, from a vehicle computer, a first location of a vehicle, identifying, in the infrastructure element, the vehicle from a plurality of detected vehicles within a field of view of an infrastructure element object detection sensor based on the received first location of the vehicle, determining, in the infrastructure element, a second location of the identified vehicle, providing, to the vehicle computer, from the stationary infrastructure element, the second location of the vehicle, and determining, in the vehicle computer, a third location of the vehicle based on the infrastructure-determined second location and the first location.

The method may further include determining a first vehicle state vector including the first location, a vehicle orientation, a vehicle linear velocity vector, a vehicle angular velocity vector, and a vehicle acceleration vector, and determining a second vehicle state vector based on (i) the infrastructure-determined vehicle location and the third location.

The method may further include determining the second vehicle state vector by applying a Kalman filter to the first vehicle state vector.

The method may further include determining the first location of the vehicle further based on data received from a vehicle location senor and determining a vehicle orientation based on data received from a vehicle orientation sensor.

The method may further include determining the first location of the vehicle, using a localization technique, based on data received from a vehicle lidar sensor.

The method may further include identifying the vehicle from a plurality of detected vehicles within a field of view of the infrastructure element object detection sensor upon determining that the detected vehicle is within an area defined based on the vehicle location received from the vehicle.

The method may further include identifying the vehicle within the field of view of the infrastructure object detection sensor upon determining that a difference between (i) an orientation of the detected vehicle in the image and (ii) a vehicle orientation included in the data received from the vehicle, is less than a threshold.

The object detection sensor may include at least one off a camera sensor, a radar sensor, and a lidar sensor.

The method may further include sending the third location to the stationary infrastructure element, receiving, from the stationary infrastructure element, a fourth location of the vehicle determined from (a) infrastructure sensor data upon identifying the vehicle from a plurality of vehicles, and (b) the third location sent by the vehicle, and determining, in the vehicle computer, a fifth location of the vehicle based on the infrastructure-determined fourth location and the third location.

Further disclosed herein is a system including a stationary infrastructure element, including a computer programmed to receive, from a vehicle computer, a first location of a vehicle, identify the vehicle from a plurality of detected vehicles within a field of view of an infrastructure element object detection sensor based on the received first location of the vehicle, determine a second location of the identified vehicle based on data received from the infrastructure element object detection sensor; and provide, to the vehicle computer, the second location of the vehicle. The vehicle computer may be programmed to determine the first location of the vehicle based on vehicle sensor data, and to determine a third location of the vehicle based on the infrastructure-determined second location and the first location.

The vehicle computer may be further programmed to send the third location to the stationary infrastructure element, and to determine a fifth location of the vehicle based on an infrastructure-determined fourth location and the third location. The computer of the infrastructure element may be further programmed to send the fourth location of the vehicle determined from (a) infrastructure sensor data upon identifying the vehicle from a plurality of vehicles, and (b) the third location sent by the vehicle computer.

The vehicle computer may be further programmed to determine a first vehicle state vector including the first location, a vehicle orientation, a vehicle linear velocity vector, a vehicle angular velocity vector, and a vehicle acceleration vector, and determine a second vehicle state vector based on (i) the infrastructure-determined vehicle location and the third location, by applying a Kalman filter to the first vehicle state vector.

The vehicle computer may be further programmed to determine a first vehicle state vector including the first location, a vehicle orientation, a vehicle linear velocity vector, a vehicle angular velocity vector, and a vehicle acceleration vector, and determine a second vehicle state vector based on (a) the third location and (b) the first vehicle state vector.

Further disclosed is a computing device programmed to execute any of the above method steps.

Yet further disclosed is a computer program product, comprising a computer-readable medium storing instructions executable by a computer processor, to execute any of the above method steps.

### Exemplary System Elements

Vehicle sensors may provide inaccurate vehicle localization. In the present context, a vehicle localization means a vehicle location (i.e., location on the ground) and/or orientation. Herein example systems and methods are disclosed to send, to a stationary infrastructure element, from a vehicle computer, a vehicle location, to identify, in the infrastructure element, the vehicle from a plurality of detected vehicles within a field of view of an infrastructure element imaging sensor based on the received vehicle location, to provide, to the vehicle computer, from the stationary infrastructure element, infrastructure-determined vehicle location, and to adjust, in the vehicle computer, the vehicle location based on the infrastructure-determined vehicle location.

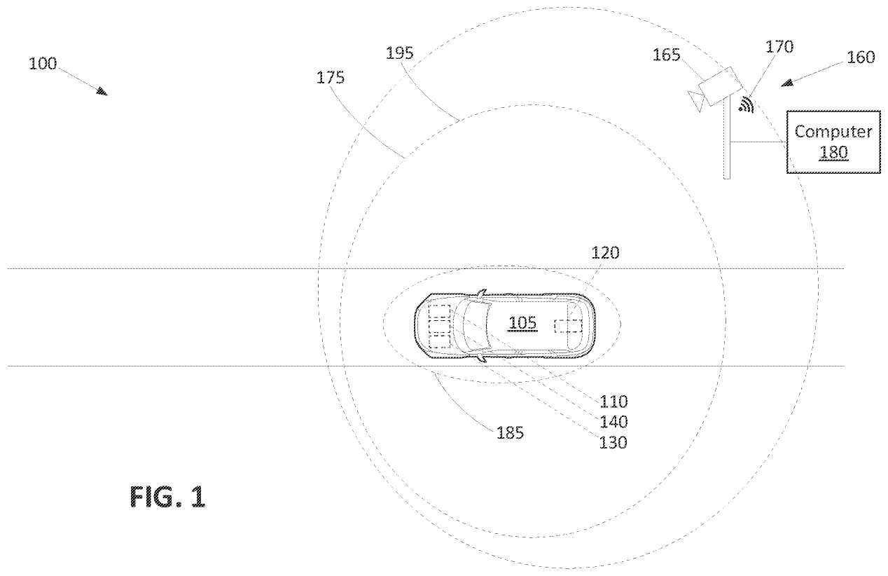

FIG. 1 illustrates an example vehicle localization system 100 including a vehicle 105 and an infrastructure element 160. The vehicle 105 may be powered in a variety of known ways, e.g., with an electric motor and/or internal combustion engine. The vehicle 105 may be a land vehicle such as a car, truck, mobile robot, etc. A vehicle 105 may include a computer 110, actuator(s) 120, sensor(s) 130, and a wireless communication interface 140.

The computer 110 includes a processor and a memory such as are known. The memory includes one or more forms of computer-readable media, and stores instructions executable by the computer 110 for performing various operations, including as disclosed herein.

The computer 110 may operate the vehicle 105 in an autonomous or a semi-autonomous mode. For purposes of this disclosure, an autonomous mode is defined as one in which each of vehicle 105 propulsion, braking, and steering are controlled by the computer 110; in a semi-autonomous mode, the computer 110 controls one or two of vehicles 105 propulsion, braking, and steering, and none of these in a non-autonomous or manual mode.

The computer 110 may include programming to operate one or more of land vehicle brakes, propulsion (e.g., control of acceleration in the vehicle by controlling one or more of an internal combustion engine, electric motor, hybrid engine, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via a vehicle 105 communications bus as described further below, more than one processor, e.g., controllers or the like included in the vehicle for monitoring and/or controlling various vehicle controllers, e.g., a powertrain controller, a brake controller, a steering controller, etc. The computer 110 is generally arranged for communications on a vehicle communication network that can include a bus in the vehicle such as a controller area network (CAN) or the like, and/or other wired and/or wireless mechanisms.

Via the vehicle 105 network, the computer 110 may transmit messages to various devices in the vehicle and/or receive messages from the various devices, e.g., an actuator 120. Alternatively or additionally, in cases where the computer 110 comprises multiple devices, the vehicle 105 communication network may be used for communications between devices represented as the computer 110 in this disclosure. Further, as mentioned below, various controllers and/or sensors may provide data to the computer 110 via the vehicle communication network.

In addition, the computer 110 may be configured for communicating through a wireless vehicular communication interface with other traffic participants (e.g., vehicles, infrastructure, pedestrian, etc.), e.g., via a vehicle-to-vehicle communication network and/or a vehicle-to-infrastructure communication network. The vehicular communication network represents one or more mechanisms by which the computers 110 may communicate with other traffic participants, e.g., an infrastructure element 160, and may be one or more of wireless communication mechanisms, including any desired combination of wireless (e.g., cellular, wireless, satellite, microwave, and radiofrequency) communication mechanisms and any desired network topology (or topologies when multiple communication mechanisms are utilized). Exemplary vehicular communication networks include cellular, Bluetooth, IEEE 802.11, dedicated short-range communications (DSRC), and/or wide area networks (WAN), including the Internet, providing data communication services.

The vehicle 105 actuators 120 are implemented via circuits, chips, or other electronic and or mechanical components that can actuate various vehicle subsystems in accordance with appropriate control signals as is known. The actuators 120 may be used to control braking, acceleration, and steering.

The sensors 130 may include a variety of devices known to provide data to the computer 110. The sensors 130 may provide data from an area surrounding the vehicle 105. The sensors 130 may include one or more object detection sensors 130 such as light detection and ranging (lidar) sensors 130, camera sensors 130, radar sensors 130, etc. An object detection sensor 130, e.g., a lidar sensor 130, may include a field of view.

The vehicle 105 includes one or more localization sensors 130 such as a Global Positioning System (GPS) sensors 130, visual odometer, etc., which may provide localization data, i.e., at least location and/or orientation data relative to a global coordinate system with an origin outside the vehicle 105, e.g., a GPS origin point on Earth. Additionally, localization data may include other data describing a position, orientation, and/or movement of a vehicle 105 such as acceleration, linear speed, angular speed, etc. The location of a vehicle 105 or other objects may be specified by location coordinates (x, y, z) with respect to a three-dimensional (3D) coordinate system. The coordinate system may be a Cartesian coordinate system including X, Y, and Z axes. Location coordinates with respect to a global coordinate system, i.e., a coordinate system that covers substantially all of the earth, are herein referred to as “global location coordinates.”

An orientation (also referred to as a pose) of the vehicle 105 is a roll φ, pitch θ, and yaw or heading ψ of the vehicle 105. The roll φ, pitch θ, and heading ψ may be specified as angles with respect to a horizontal plane and a vertical axis, e.g., as defined by a coordinate system. In the present context, a localization (or six degrees of freedom localization) of the vehicle 105 is a set of data defining a location and orientation of the vehicle 105. In the present context, an orientation (or pose) of a vehicle 105 with respect to a global coordinate system having an origin such as the GPS origin is referred to as a “global orientation” of the vehicle 105.

A vehicle computer 110 may be programmed to determine a localization of the vehicle 105 with reference to the global coordinate system based on data received from the vehicle 105 sensors 130. For example, the computer 110 may be programmed to determine the location of the vehicle 105 based on data received from the vehicle 105 GPS sensor 130, and/or to determine the vehicle orientation based on data received from a vehicle 105 orientation sensor 130, e.g., yaw sensor 130, a visual odometer sensor 130, etc. The computer 110 may be programmed to wirelessly, e.g., via a vehicle-to-vehicle communication network, send the localization data of the vehicle 105 to, e.g., an infrastructure element 160.

The computer 110 may be programmed to determine, for the vehicle 105, a linear velocity vector (vₓ, v_{y}, v_{z}), angular velocity vector (wᵣₒₗₗ, w_{pitch}, w_{heading}), orientation vector including a roll φ, pitch θ, and heading ψ, and/or linear acceleration vector (aₓ, a_{y}, a_{z}) based on data received from the vehicle 105 sensors 130, e.g., velocity sensor 130, yaw sensor 130, acceleration sensor 130, etc. Parameters vₓ, v_{y}, v_{z} represent vehicle 105 speed in each of X, Y, and Z axes of the coordinate system. Parameters wᵣₒₗₗ, w_{pitch}, w_{heading} represent a rate of change in the vehicle 105 φ, pitch θ, and heading ψ. Parameters aₓ, a_{y}, a_{z} represent an acceleration of the vehicle 105 in each of X, Y, and Z axes of the coordinate system.

Vehicle sensor 130 data can have an error (meaning a deviation from ground truth, i.e., data that would be reported if accurately and precisely measuring the physical world). Sensor 130 error can be caused by various factors such as sensor design, weather conditions, debris or foreign matter on a sensor lens, sensor calibration (or miscalibration), etc. With reference to Equation (1), P_{AV}^{w} represents a true localization of the vehicle 105 relative to the coordinate system 190, P′_{AV}^{w} represents the received localization data received from the vehicle 105 sensor 130, and e₁ is the error vector. For example, Equation (2) shows an example error vector e₁ including error values eₓ, e_{y}, e_{z}, e_{φ}, e_{θ}, e_{ψ}, for coordinates x, y, z, and orientation values including roll φ, pitch θ, and heading ψ. Each of the error values may values eₓ, e_{y}, e_{z}, e_{φ}, e_{θ}, e_{ψ}, may be a positive or negative number.

P_{AV}^{w}=P′_{AV}^{w}+e₁ (1)

e₁=[eₓ, e_{y}, e_{z}, e_{φ}, e_{θ}, e_{ψ}] (2)

The computer 110 may be configured for communicating through a wireless communication interface 140 with other vehicles 105, an infrastructure element 160, etc., e.g., via a vehicle-to-vehicle (V2V), a vehicle-to-infrastructure (V-to-I) communication, and/or a vehicle-to-everything (V2X) communication network (i.e., communications that can include V2V and V2I). The communication interface 140 may include elements for sending (i.e., transmitting) and receiving radio frequency (RF) communications, e.g., chips, antenna(s), transceiver(s), etc.

The vehicle 105 computers 110 may communicate with other vehicles 105 and/or infrastructure element(s) 160, and may utilize one or more of wireless communication mechanisms, e.g., a communication interface 140, including any desired combination of wireless and wired communication mechanisms and any desired network topology (or topologies when a plurality of communication mechanisms are utilized). A V2X communication network may have multiple channels, each identified by an identifier, e.g., channel number.

An infrastructure element 160 is typically stationary, e.g., can include a tower, pole, road element such as a bridge, etc., where such stationary physical structure in turn may include an antenna 170 for a transceiver (not shown), and a computer 180 mounted thereto. The computer 180 may be located at an infrastructure element 160 location and/or at a second location communicatively connected to the infrastructure element 160 via a wired and/or wireless communication network.

The infrastructure computer 180 includes a processor and a memory such as are known. The memory includes one or more forms of computer-readable media, and stores instructions executable by the computer 180 for performing various operations, including as disclosed herein. The computer 180 may be configured for communicating through one or more antennas 170 with vehicles 105 via a V2X communication protocol. Additionally or alternatively, an infrastructure computer 180 may include a dedicated electronic circuit including an ASIC that is manufactured and/or configured for a particular operation, e.g., communicating with vehicle(s) 105. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, e.g. stored in a memory electrically connected to the FPGA circuit. In some examples, a combination of processor(s), ASIC(s), and/or FPGA circuits may be included inside a chip packaging.

The infrastructure element 160 may have a specified communication coverage area 175. A coverage area 175, in the present context, is an area in which the infrastructure element 160 can communicate with another computer, e.g., a vehicle 105 computer 110, etc. Dimensions and/or a shape of area 175 are typically based on a communication technique, communication frequency, communication power, etc., of the infrastructure element 160 as well as environmental features (i.e., an arrangement of natural and artificial physical features of an area), a topography (i.e., changes in elevation), etc., of area 175, etc.

In one example, a coverage area 175 is an area that is defined by a range of short-wave communications. In another example (not shown), the coverage area 175 is a circular area that surrounds a location of the infrastructure element 160 with a diameter, e.g., 1050 meters (m). In yet another example (not shown), area 175 may be oval-shaped and centered at the location of the infrastructure element 160. A location and dimensions of a coverage area 175 may be specified with respect to a coordinate system, e.g., a Cartesian coordinate system such as mentioned above In a Cartesian coordinate system, coordinates of points may be specified by X, Y, and Z coordinates. X and Y coordinates, i.e., horizontal coordinates, may be global positioning system (GPS) coordinates (i.e., lateral and longitudinal coordinates) or the like, whereas a Z coordinate may specify a vertical component to a location, i.e., a height (or elevation) of a point from a specified horizontal plane, e.g., a sea level.

The infrastructure element 160 is typically permanently fixed at, i.e., does not move from, a location in an area 175, e.g., an infrastructure element 160 can be mounted to a stationary object such as a pole, post, road overpass, sign, etc. One or more vehicles 105 may be within the coverage area 175 of the infrastructure element 160. A coverage area 175 may include road(s) that are two-way or one-way, intersections, parking areas, etc.

An infrastructure element 160 can include one or more object detection sensors 165 with a field of view 195. An object detection sensor 165 provides object data, i.e., a measurement or measurements via a physical medium that provide information about an object, e.g., a location, distance, dimensions, type, etc., to the computer 180, e.g., via a wired or wireless communication. For example, the physical medium can include sound, radio frequency signals, visible light, infrared, or near-infrared light, etc. An object detection sensor 156 may include a camera sensor, a lidar, and/or a radar sensor. The computer 180 may be programmed to determine object data (object detection sensor data) based on data received from a sensor 165, e.g., point cloud data received from a lidar sensor 165, image data received from a camera sensor 165, high resolution radar sensor 165, thermal imaging sensor 165, etc. Object data, in the present context, may be presented as an image, e.g., a 2D (two-dimensional) representation of point cloud, a high resolution radar image, and/or a camera image. Thus, as discussed below, the computer 180 may detect objects in the received object data using image processing techniques. The field of view 195, in the present context, encompasses an area on the ground surface. Thus, object data received from the object detection sensor(s) 165 may include objects, vehicle(s) 105, buildings, road surface, etc. The field of view 195 may have various shapes such as ovular, trapezoidal, circular, etc. A coverage area 175 of an infrastructure element 160 may include the field of view 195 of the infrastructure element 160 object detection sensor 165. Thus, the infrastructure element 160 computer 180 can communicate via wireless communications with a vehicle 105 within the field of view 195 of the infrastructure element object detection sensor 165. As discussed below, the computer 180 may be programmed to localize objects, e.g., a vehicle 105, within the field of view 195, based on object detection sensor 165 data, thereby determining a location and/or orientation of an object within the field of view 195.

In the present context, a vehicle 105 location that is determined by the infrastructure element 160 computer 180 based on data received from the object detection sensor 165, is referred to as an infrastructure-determined vehicle location, and can be denoted by the notation Q′_{AV}^{w}. The computer 180 may be programmed using image processing techniques, to determine a location and/or orientation of objects such as a vehicle 105 within the field of view 195 relative to, e.g., the coordinate system. The infrastructure element 160 sensor 165 data also typically includes error. With reference to Equation (3), Q′_{AV}^{w} represents infrastructure-determined localization of the vehicle 105, and e₂ represents an error included in estimating the vehicle 105 localization by the infrastructure element 160 sensor 165. Error e₂ may include error value(s), each specifying error in determining location coordinates x′, y′, z′ and/or orientation φ′, θ′, ψ′ based on object detection sensor 165 data.

P_{AV}^{w}=Q′_{AV}^{w}+e₂ (3)

The computer 180 may store data specifying a location of the field of view 195 relative to the coordinate system and to determine the location coordinates x′, y′, z′ and/or orientation φ′, θ′, ψ′ of an object, e.g., the vehicle 105, based in part of the stored data. In one example, the computer 180 may store data specifying location coordinates of multiple reference points, e.g., 3, on the ground surface, within the field of view 195, relative to the coordinate system. The computer 180 may be programmed, using geometrical and optical techniques, to determine a location and/or orientation of an object, e.g., the vehicle 105, detected in the received object detection sensor 165 data based on the stored coordinates of the reference points and object detection sensor characteristics such as a camera sensor focal distance, image resolution, etc. The computer 180 may be programmed, e.g., using machine learning techniques, to detect a vehicle 105 in the object data and determine vehicle 105 location data further based on stored location data of the infrastructure element 160.

The vehicle 105 computer 110 can be programmed to send a vehicle 105 location, to a stationary infrastructure element 160. The computer 180 in the infrastructure element 160 can be programmed to identify the vehicle 105 from vehicles 105 detected within a field of view 195 of an infrastructure element 160 object detection sensor 165 based on the received vehicle 105 location and provide, to the vehicle 105 computer 180, an infrastructure-determined vehicle 105 location. The vehicle 105 computer 110 can be programmed to adjust the vehicle 105 location based on the infrastructure-determined vehicle 105 location.

The computer 180 may be programmed to detect one or more vehicles 105 in the received object data from the object detection sensor 165. The computer 110 may be programmed to identify the vehicle 105 among other vehicles 105 based on the received localization data of the vehicle 105. As discussed above, the computer 180 may receive a location x′, y′, z′ and/or orientation φ′, θ′, ψ′ of the vehicle 105 via the wireless communications. The computer 180 may be programmed to identify the vehicle 105 among detected vehicles 105 based on the received location and/or orientation of the vehicle 105. In one example, the computer 180 may identify the vehicle 105 based on an area 185 defined based on the received location coordinates of the vehicle 105. The area 185 may be defined as an area centered at the location coordinates x, y, z of the vehicle 105, e.g., of some reference point selected in or on the vehicle 105, received via wireless communications, having dimensions defined based on the vehicle 105 dimensions. Dimensions of the area 185 may be defined in relation to the vehicle 105 dimensions, e.g., an oval-shaped area having a length equal to 1.5 times the length of the vehicle 105 and a width equal to 1.5 times width of the vehicle 105. Additionally or alternatively, the area 185 may have other shapes, e.g., rectangular, circular, etc. The computer 180 may identify the vehicle 105 in object data received from the object detection sensor 165 upon determining that a reference point 150 having location coordinates x′, y′, z′ of a vehicle 105 detected in the received object data is within the area 185 defined based on the location coordinates x, y, z of the vehicle 105 received via the wireless communications.

Additionally or alternatively, the computer 180 may identify the vehicle 105 in the received object data based on the orientation of the vehicle 105 received from the vehicle 105 via the wireless communications. In one example, the computer 180 is programmed to determine differences Δφ, Δθ, Δψ between the received roll φ, pitch θ, and heading 104 of the vehicle 105 and a roll φ′, pitch θ′, and heading ψ′ of a detected vehicle 105 in the object data, and identify the vehicle 105 upon determining that each difference Δφ, Δθ, Δψ is less than a respective threshold φT, θT, ψT. In one example, each of the thresholds φT, θT, ψT is 5 degrees. The threshold may be determined based on a one or more of (i) a vehicle 100 location sensor 130 error, (ii) error in vehicle 100 localization algorithm, (iii) an infrastructure sensor 165 error, (iv) error in computer 180 localization algorithm, and (v) a stored error margin. As discussed above, sensors 130, 165 data may include error. Additionally, localization data output of algorithms implemented in computers 110, 180 may include error. An error margin may be a value empirically determined, e.g., 20 centimeter for longitudinal or lateral location and 1 degree for orientation angles roll φ, pitch θ, and heading ψ. In one example, the threshold may be a sum of the vehicle 100 sensor 130 error, infrastructure element 160 sensor 165 error, vehicle 100 localization algorithm error, infrastructure element 160 localization algorithm error, and the stored margin of error.

In yet another example, the computer 180 may be programmed to identify the vehicle 105 in the received object data upon determining that (i) the vehicle 105 detected in the object data is located in the area 185 defined based on the received location coordinates of the vehicle 105, and (ii) the difference in heading Δψ between the vehicle 105 and the detected vehicle 105 in the object data is less than a respective threshold ψT.

In the present context, upon identifying the vehicle 105 in the received object data, the localization of vehicle 105 determined based on the received object data, is the infrastructure-determined vehicle 105 localization. Thus, location coordinates x′, y′, z′ and orientation φ′, θ′, ψ′ represent the infrastructure-determined localization Q′_{AV}^{w} of the vehicle 105. For example, localization Q′_{AV}^{w} may be a vector including 6 elements i.e., coordinates x′, y′, z′ and orientation φ′, θ′, ψ′.

The computer 180 may be further programmed to determine and store a vehicle 105 state vector, as shown in Equation (4). The vehicle state vector is the estimated vehicle localization data P′_{AV}^{w} which includes (i) a vehicle location x, y, z, and (ii) vehicle orientation φ, θ, ψ, concatenated with other data available from the vehicle 105 sensors 130 that may include the vehicle linear velocity vₓ, v_{y}, v_{z}, vehicle angular velocity wᵣₒₗₗ, w_{pitch}, w_{heading}, and vehicle acceleration aₓ, a_{y}, a_{z}.

$$\begin{matrix}μ = [ {P}_{AV}^{′ w} , {v}_{x} , {v}_{y} , {v}_{z} , {w}_{roll} , {w}_{pitch} , {w}_{heading} , {a}_{x} , {a}_{y} , {a}_{z} ] \\ = [ x , y , z , φ , θ , Ψ , {v}_{x} , {v}_{y} , {v}_{z} , {w}_{roll} , {w}_{pitch} , {w}_{heading} , {a}_{x} , {a}_{y} , {a}_{z} ]\end{matrix} \qquad ( 4 )$$

The vehicle 105 computer 110 can be programmed to determine the vehicle 15 state vector μ based on data received from the vehicle 105 sensors 130, e.g., GPS sensor 130, lidar sensor 130, yaw sensor 130, etc., As discussed above, the computer 110 can be programmed to send the vehicle 105 data, e.g., location x, y, z and/or orientation φ, θ, ψ to the infrastructure element 160 computer 180. Upon receiving the infrastructure-determined vehicle 105 localization data including infrastructure-determined location x′, y′, z′ and/or infrastructure-determined orientation φ′, θ′, ψ′, the vehicle 105 computer 110 may be programmed to adjust the vehicle state vector μ.

In one example, the computer 110 may be programmed to apply a Kalman filter to update the vehicle state vector μ using infrastructure-determined localization data. The computer 110 may be programmed to receive vehicle 105 location data from vehicle 105 sensors 130, e.g., cyclically based on a first cycle time, e.g., of 5 milliseconds (ms). The computer 110 may be programmed to receive infrastructure-determined localization data from the infrastructure element 160, e.g., cyclically e.g., based on a second cycle time of 200 ms.

μ′ₖ=F μₖ₋₁ (5)

C′ₖ=FCₖ₋₁F^{T}+W (6)

μₖ₋₁ is the current vehicle state vector determined at timestep k−1, F is a state transition matrix, Cₖ₋₁ is a covariance matrix, and W is a process noise matrix.

[symbol]

=C′ₖH^{T}(HC′ₖH^{T}+R_{Q})⁻¹ (7)

μₖ=μ′ₖ+ [symbol] (Q′_{w}^{AV}−Hμ′ₖ) (8)

Cₖ=(I−KH)C′ₖ (9)

Q′_{w}^{AV} is the infrastructure-determined localization data received at timestep k, μₖ is the adjusted vehicle state vector determined at timestep k, H is an observation matrix, I is an identity matrix, and R_{Q} is a measurement matrix that represents the error covariance of the measurement Q′_{w}^{AV}.

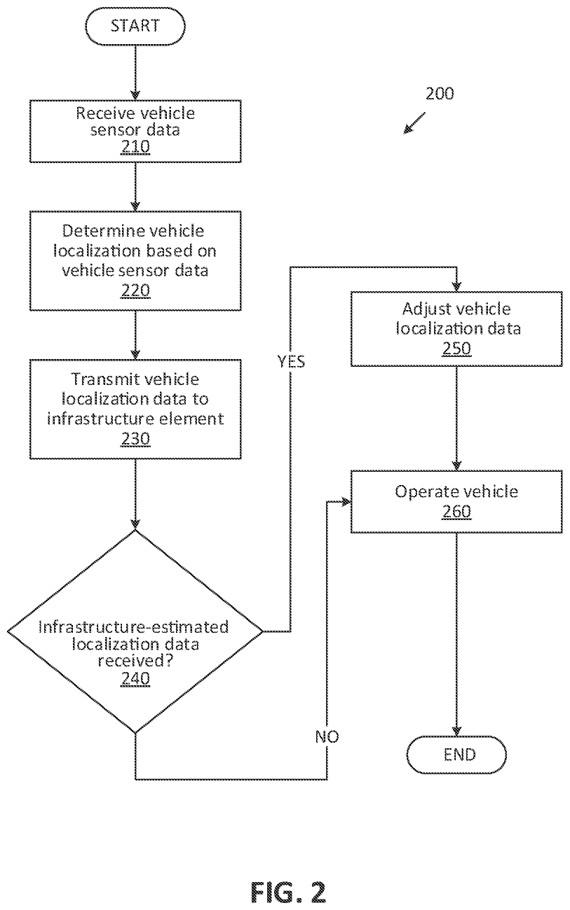

FIG. 2 shows a flowchart of an exemplary process 200 for operating a vehicle 105. A vehicle 105 computer 110 may be programmed to execute blocks of the process 200.

The process 200 begins in a block 210, in which the computer 110 receives data from vehicle 105 sensors 130. The computer 110 may be programmed to receive data from a vehicle 105 GPS sensor 130, yaw rate sensor 130, speed sensor 130, lidar sensor 130, etc.

In a next block 220, the computer 110 determines vehicle 105 localization P′_{AV}^{w} based on the received sensor 130 data. Additionally, the computer 110 may be programmed to determine a vehicle 105 state vector μ, as defined in Equation (4), based on the received vehicle 105 sensor 130 data.

Next, in a block 230, the computer 110 transmits the vehicle 105 localization P′_{AV}^{w} to an infrastructure element 160. In one example, the computer 110 broadcasts the localization P′_{AV}^{w} via the wireless interface 140. The transmitted data additionally includes data to identify the vehicle 105, e.g., a vehicle 105 identifier such as a network identifier, a VIN (vehicle identification number), etc. The computer 110 may be programmed to transmit the vehicle 105 localization P′_{AV}^{w} e.g., every 10 ms.

Next, in a decision block 240, the computer 110 determines whether an infrastructure-determined localization Q′_{AV}^{w} for the vehicle 105 is received via the wireless interface 140 from an infrastructure element 160. The computer 110 may be programmed to determine whether a received infrastructure-determined localization Q′_{AV}^{w} is a localization of the vehicle 105, upon determining that a vehicle 105 identifier included in the received data is same as the vehicle 105 identifier. Additionally or alternatively, the computer 110 may be programmed to determine that the received infrastructure-determined localization is a localization for the vehicle 105 upon determining that the received infrastructure-determined localization Q′_{AV}^{w} includes location coordinates within the area 185, as defined with respect to FIG. 1. If the computer 110 determines that the infrastructure-determined localization Q′_{AV}^{w} of the vehicle 105 is received then the process 200 proceeds to a block 250; otherwise the process 200 proceeds to a block 260.

In the block 250, the computer 110 adjusts the location x, y, z and/or orientation φ, θ, ψ of the vehicle 105 based on the infrastructure-determined localization Q′_{AV}^{w}. The computer 110 may be programmed to implement Equations (5)-(9), to adjust the determine an adjusted vehicle 105 state vector thereby determining the adjusted location x, y, z and/or orientation φ, θ, ψ of the vehicle 105.

In the block 260, which can be reached from the decision block 240 or the block 250, the computer 110 operates the vehicle 105, at least in part, based on the vehicle 105 location x, y, z and/or orientation φ, θ, ψ. Thus, the computer 110 may operate the vehicle 105 based on the vehicle 105 location x, y, z and/or orientation φ, θ, ψ (i) that is determined based on the vehicle 105 sensor 130 if the block 260 is reached from the decision block 240, or (ii) additionally adjusted based on the infrastructure-determined localization Q′_{AV}^{w}, if the block 260 is reached from the block 250. The computer 110 may operate the vehicle 105 by actuating a vehicle 105 propulsion, steering, and/or braking actuator 120.

Following the block 260 the process 200 ends, or alternatively, returns to the block 210, although not shown in FIG. 2.

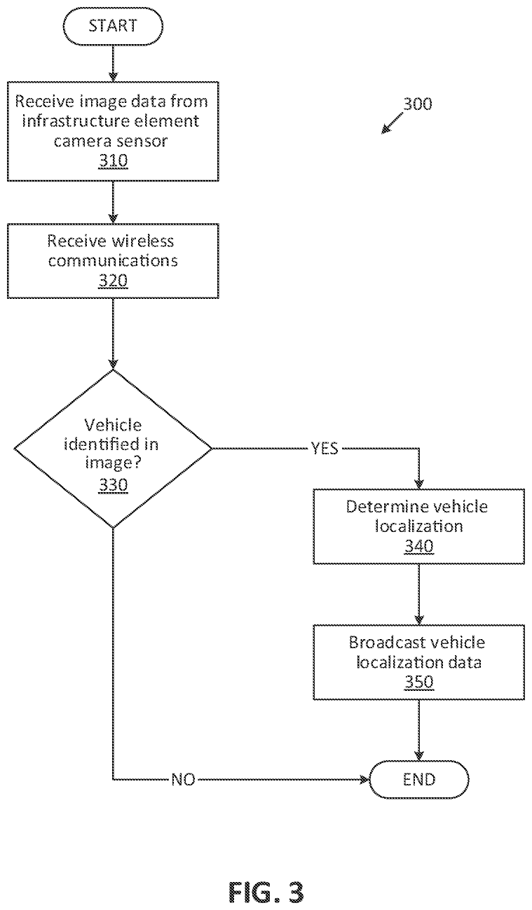

FIG. 3 is a flowchart of an exemplary process 300 for operating an infrastructure element 160. A computer 180 of the infrastructure element 160 may be programmed to execute blocks of the process 300.

The process 300 begins in a block 310, in which the computer 180 receives object data from an object detection sensor 165 of the infrastructure element 160. The computer 180 may be programmed, based on image processing techniques, to detect objects such as vehicle(s) 105 in the received object data.

Next, in a block 320, the computer 180 receives wireless communication, e.g., from vehicle(s) 105. The received data from a vehicle 105 may include (i) vehicle 105 localization P′_{AV}^{w} determined based on vehicle 105 sensor 103 data, and (ii) a vehicle 105 identifier.

Next, in a decision block 330, the computer 180 determines whether a vehicle 105 is identified in the object data received from the infrastructure element 160 object detection sensor 165. The computer 180 may be programmed to detect vehicle(s) 105 in the received object data. using image processing techniques. The computer 180 may be programmed to identify a vehicle 105 further based on vehicle 105 localization P′_{AV}^{w} received via the wireless communications. The computer 180 may be programmed to identify a vehicle 105 detected in the object data upon determining that the vehicle 105 is detected within an area 185 defined based on the received localization P′_{AV}^{w}. The computer 180 may be programmed to identify a first vehicle 105 in the object data in a first area 185 defined based on a first localization P′_{AV}^{w} received via the wireless communications and a second vehicle 105 within a second area 185 defined based on a second localization P′_{AV}^{w} received via the wireless communications. If the computer 180 identifies a vehicle 105 in the received object data, then the process 300 proceeds to a block 340; otherwise the process 300 ends, or alternatively, returns to the block 210 although not shown in FIG. 3.

In the block 340, the computer 180 determines infrastructure-determined vehicle 105 localization Q′_{AV}^{w} based on the received object data. The computer 180 may be programmed to implement image processing techniques to detect a vehicle 105 location x′, y′, z′ and/or orientation φ′, θ′, ψ′, and to determine the localization Q′_{AV}^{w} including the determined location x′, y′, z′ and/or orientation φ′, θ′, ψ′. Additionally, the computer 180 may be programmed to include other data such as velocity vector (vₓ, v_{y}, v_{z}), angular velocity vector (wᵣₒₗₗ, w_{pitch}, w_{heading}) in the infrastructure-determined localization Q′_{AV}^{w}.

In the block 350, the computer 180 broadcasts the infrastructure-determined localization Q′_{AV}^{w} and the vehicle 105 identifier via the wireless communications. Additionally or alternatively, the computer 180 may be programmed, upon detecting multiple vehicles 105 in the received object data, to broadcast a first message including the first vehicle 105 identifier and the first vehicle 105 infrastructure-determined localization Q′_{AV}^{w}, and a second message including the second vehicle 105 identifier and the second vehicle 105 infrastructure-determined localization Q′_{AV}^{w}.

Following the block 350, the process 300 ends, or alternatively returns to the block 310, although not shown in FIG. 3.

Unless indicated explicitly to the contrary, “based on” means “based at least in part on” and/or “based entirely on.”

Computing devices as discussed herein generally each includes instructions executable by one or more computing devices such as those identified above, and for carrying out blocks or steps of processes described above. Computer executable instructions may be compiled or interpreted from computer programs created using a variety of programming languages and/or technologies, including, without limitation, and either alone or in combination, Java™, C, C++, Visual Basic, Java Script, Perl, HTML, etc. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in the computing device is generally a collection of data stored on a computer readable medium, such as a storage medium, a random-access memory, etc.

A computer readable medium includes any medium that participates in providing data (e.g., instructions), which may be read by a computer. Such a medium may take many forms, including, but not limited to, nonvolatile media, volatile media, etc. Nonvolatile media include, for example, optical or magnetic disks and other persistent memory. Volatile media include dynamic random-access memory (DRAM), which typically constitutes a main memory. Common forms of computer readable media include, for example, a floppy disk, a flexible disk, hard disk, magnetic tape, any other magnetic medium, a CDROM, DVD, any other optical medium, any other physical medium with patterns of holes, a RAM, a PROM, an EPROM, a FLASH, an EEPROM, any other memory chip or cartridge, or any other medium from which a computer can read.

With regard to the media, processes, systems, methods, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of systems and/or processes herein are provided for the purpose of illustrating certain embodiments, and should in no way be construed so as to limit the disclosed subject matter.

Accordingly, it is to be understood that the present disclosure, including the above description and the accompanying figures and below claims, is intended to be illustrative and not restrictive. Many embodiments and applications other than the examples provided would be apparent to those of skill in the art upon reading the above description. The scope of the invention should be determined, not with reference to the above description, but should instead be determined with reference to claims appended hereto and/or included in a nonprovisional patent application based hereon, along with the full scope of equivalents to which such claims are entitled. It is anticipated and intended that future developments will occur in the arts discussed herein, and that the disclosed systems and methods will be incorporated into such future embodiments. In sum, it should be understood that the disclosed subject matter is capable of modification and variation.

What is claimed is:

1. A system comprising, a computer for a vehicle including a processor and a memory, the memory storing instructions executable by the processor to:
determine a first location of the vehicle;
send the first location to a stationary infrastructure element;
receive, from the stationary infrastructure element, a second location of the vehicle determined from (a) infrastructure sensor data upon identifying the vehicle from a plurality of vehicles, and (b) the first location sent by the vehicle; and
determine a third location of the vehicle based on the infrastructure-determined second location and the first location.

2. The system of claim 1, wherein the instructions further include instructions to:
determine a first vehicle state vector including the first location, a vehicle orientation, a vehicle linear velocity vector, a vehicle angular velocity vector, and a vehicle acceleration vector; and
determine a second vehicle state vector based on (a) the third location and (b) the first vehicle state vector.

3. The system of claim 2, wherein the instructions further include instructions to determine the second vehicle state vector by applying a Kalman filter to the first vehicle state vector.

4. The system of claim 1, wherein the instructions further include instructions to identify the vehicle from a plurality of detected vehicles within a field of view of an infrastructure element object detection sensor upon determining that the detected vehicle is within an area defined based on the first location of the vehicle received from the vehicle.

5. The system of claim 4, wherein the instructions further include instructions to identify the vehicle within the field of view of the infrastructure element object detection sensor upon determining that a difference between (i) an orientation of the detected vehicle in an image and (ii) a vehicle orientation included in the data received from the vehicle, is less than a threshold.

6. The system of claim 5, wherein the infrastructure sensor data includes at least one of a camera image, radar data, or lidar data.

7. The system of claim 1, wherein the instructions further include instructions to:
send the third location to the stationary infrastructure element;
receive, from the stationary infrastructure element, a fourth location of the vehicle determined from (a) infrastructure sensor data upon identifying the vehicle from a plurality of vehicles, and (b) the third location sent by the vehicle; and
determine a fifth location of the vehicle based on the infrastructure-determined fourth location and the third location.

8. A method comprising:
sending, to a stationary infrastructure element, from a vehicle computer, a first location of a vehicle;
identifying, in the infrastructure element, the vehicle from a plurality of detected vehicles within a field of view of an infrastructure element object detection sensor based on the received first location of the vehicle;
determining, in the infrastructure element, a second location of the identified vehicle;
providing, to the vehicle computer, from the stationary infrastructure element, the second location of the vehicle; and
determining, in the vehicle computer, a third location of the vehicle based on the infrastructure-determined second location and the first location .

9. The method of claim 8, further comprising:
determining a first vehicle state vector including the first location, a vehicle orientation, a vehicle linear velocity vector, a vehicle angular velocity vector, and a vehicle acceleration vector; and
determining a second vehicle state vector based on (i) the infrastructure-determined vehicle location and the third location.

10. The method of claim 9, further comprising determining the second vehicle state vector by applying a Kalman filter to the first vehicle state vector.

11. The method of claim 8, further comprising determining the first location of the vehicle further based on data received from a vehicle location senor and determining a vehicle orientation based on data received from a vehicle orientation sensor.

12. The method of claim 8, further comprising determining the first location of the vehicle, using a localization technique, based on data received from a vehicle lidar sensor.

13. The method of claim 8, further comprising identifying the vehicle from a plurality of detected vehicles within a field of view of the infrastructure element object detection sensor upon determining that the detected vehicle is within an area defined based on the vehicle location received from the vehicle.

14. The method of claim 12, further comprising identifying the vehicle within the field of view of the infrastructure element object detection sensor upon determining that a difference between (i) an orientation of the detected vehicle in an image and (ii) a vehicle orientation included in the data received from the vehicle, is less than a threshold.

15. The method of claim 14, wherein the object detection sensor includes at least one off a camera sensor, a radar sensor, and a lidar sensor.

16. The method of claim 8, further comprising:
sending the third location to the stationary infrastructure element;
receiving, from the stationary infrastructure element, a fourth location of the vehicle determined from (a) infrastructure sensor data upon identifying the vehicle from a plurality of vehicles, and (b) the third location sent by the vehicle; and
determining, in the vehicle computer, a fifth location of the vehicle based on the infrastructure-determined fourth location and the third location.

17. A system, comprising:
a stationary infrastructure element, including a computer programmed to:
receive, from a vehicle computer, a first location of a vehicle;
identify the vehicle from a plurality of detected vehicles within a field of view of an infrastructure element object detection sensor based on the received first location of the vehicle;
determine a second location of the identified vehicle based on data received from the infrastructure element object detection sensor; and
provide, to the vehicle computer, the second location of the vehicle; and
the vehicle computer, programmed to:
determine the first location of the vehicle based on vehicle sensor data; and
determine a third location of the vehicle based on the infrastructure-determined second location and the first location.

18. The system of claim 17, wherein:
the vehicle computer is further programmed to:
send the third location to the stationary infrastructure element; and
determine a fifth location of the vehicle based on an infrastructure-determined fourth location and the third location; and
the computer of the infrastructure element is further programmed to send the fourth location of the vehicle determined from (a) infrastructure sensor data upon identifying the vehicle from a plurality of vehicles, and (b) the third location sent by the vehicle computer.

19. The system of claim 17, wherein the vehicle computer is further programmed to:
determine a first vehicle state vector including the first location, a vehicle orientation, a vehicle linear velocity vector, a vehicle angular velocity vector, and a vehicle acceleration vector; and
determine a second vehicle state vector based on (i) the infrastructure-determined vehicle location and the third location, by applying a Kalman filter to the first vehicle state vector.

20. The system of claim 17, wherein the vehicle computer is further programmed to:
determine a first vehicle state vector including the first location, a vehicle orientation, a vehicle linear velocity vector, a vehicle angular velocity vector, and a vehicle acceleration vector; and
determine a second vehicle state vector based on (a) the third location and (b) the first vehicle state vector.
